(19) United States
(12) Patent Application Publication
(10) Pub. No.: US 2021/0318796 A1
(43) Pub. Date: Oct. 14, 2021

(54) System and Method for Fabricating Decorative Surfaces

(71) Applicant: Matrix Analytics Corporation, Ridgefield Park, NJ (US)

(72) Inventors: Anil Bandari, Ridgefield Park, NJ (US); Alakar S. Ramani, Ridgefield Park, NJ (US)

(21) Appl. No.: 17/266,783

(22) PCT Filed: Aug. 19, 2019
(86) PCT No.: PCT/US19/47042

§ 371 Date: Feb. 8, 2021

Related U.S. Application Data
(60) Provisional application No. 62/719,366, filed on Aug. 17, 2018.

(51) Int. Cl. G06F 3/0484; G06T 11/00; G06F 3/0482; E04F 15/12; G06Q 30/06; G06F 16/958

(52) U.S. Cl. CPC G06F 3/04847; G06T 11/001; G06F 3/0482; G06Q 20/127; G06Q 30/0621; G06F 16/958; G06T 2200/24; E04F 15/126

(57) ABSTRACT

A system and method include a software application that creates Terrazzo samples on computers to visualize the desired formulation of chips, with the flexibility of choosing different background colors based on various color palettes. The system and method create a digital image of an actual sample. An architect, designer, or user can choose dimensions, stone, glass, glass bead, mother of pearl, etc. as parameters. With the system and method, an architect or designer can be very creative and experiment with various combinations before asking a supplier or contractor for actual samples. The application reduces time, resources and gives more freedom to architects to create what the architect considers the best combination of parameters for the project. All the experimentation can be done using the software application, and a final sample can be made using actual material.

### CROSS-REFERENCE TO RELATED APPLICATION

This application claims priority to U.S. Provisional Application No. 62/719,366, filed on Aug. 17, 2018, which is incorporated by reference in its entirety.

### FIELD

The present disclosure relates to decorative surfaces and in particular to a system and method for fabricating decorative surfaces.

### BACKGROUND

In the prior art, during the fabrication of decorative surfaces, such as Terrazzo-style floors and walls, actual samples are created by mixing epoxy with chips of desired combinations, and the mixture is then poured into a machine which creates the slabs of samples. The samples are later ground to have a smooth finish. This process usually takes days to complete. However, architects and designers of such decorative surfaces may wish to test different combinations long before finalizing the sample for the job. As well, it may be difficult to keep accurate records of the numerous combinations of formulations.

Therefore, a need exists for a system and method which allows a designer to accurately generate digital samples of decorative surfaces, prior to creation of corresponding physical decorative surfaces. A need also exists for a system and method for fabricating physical decorative surfaces based on accurate pre-determined formulations.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

A system and method of the present invention include a software application that creates Terrazzo samples on computers to visualize the desired formulation of chips, with the flexibility of choosing different background colors based on various color palettes, for example, the SHERWIN-WILLIAMS color palette. The system and method create a digital image of an actual sample. An architect, designer, or user can choose dimensions, stone, glass, glass bead, mother of pearl, etc. as parameters. With the system and method of the present invention, an architect or designer can be very creative and experiment with various combinations before asking a supplier or contractor for actual samples. The application reduces time, resources and gives more freedom to architects to create what the architect considers the best combination of parameters for the project. All the experimentation can be done using the software application, and a final sample can be made using actual material.

In one embodiment, a system of the present invention comprises: an input device for receiving user inputs from a user; a processor, executing a predetermined software application, for processing the user inputs to create a decorative image; and a display for displaying the decorative image. The system further comprises a fabrication system for fabricating a physical decorative surface corresponding to the decorative image. The system further comprises a web server for displaying a website on the display; wherein the display displays a browser, and displays the decorative image through the browser; and wherein the user enters the user inputs to the website through the browser. The decorative image represents a plurality of physical chips constituting a physical decorative surface. The processor generates a chip composition specification of the decorative image from the user inputs. The system further comprises a fabrication system for fabricating the physical decorative surface corresponding to the decorative image from the chip composition specification. The user inputs are selected from the group of chip type, chip color, chip size, and chip percentage in the decorative image. The user inputs indicate a first color palette selected from a plurality of predetermined color palettes, wherein the chip color is determined by the first color palette.

In another embodiment, a system of the present invention comprises an input device for receiving user inputs from a user; a processor, executing a predetermined software application, for processing the user inputs to create a decorative image, wherein the decorative image represents a plurality of physical chips constituting a physical decorative surface; and a fabrication system for fabricating the decorative surface corresponding to the decorative image. The system further comprises a display; and a web server for generating a website on the display; wherein the display displays a browser, and displays the decorative image through the browser; and wherein the user enters the user inputs to the website through the browser. The processor generates a chip composition specification of the decorative image from the user inputs. The fabrication system fabricates the decorative surface corresponding to the decorative image from the chip composition specification. The user inputs are selected from the group of chip type, chip color, chip size, and chip percentage in the decorative image. The user inputs indicate a first color palette selected from a plurality of predetermined color palettes, wherein the chip color is determined by the first color palette.

In a further embodiment, a method of the present invention comprises receiving user inputs from a user using an input device; executing a predetermined software application using a processor for processing the user inputs, thereby creating a decorative image; and displaying the decorative image on a display. The method further comprises fabricating a physical decorative surface corresponding to the decorative image using a fabrication system. The method further comprises displaying a website on the display using a web server; displaying a browser on the display; displaying the decorative image through the browser; and entering, by the user, the user inputs to the website through the browser. The user inputs are selected from the group of chip type, chip color, chip size, and chip percentage in the decorative image. The decorative image represents a plurality of physical chips constituting a physical decorative surface. The method further comprises generating a chip composition specification of the decorative image from the user inputs; and fabricating the physical decorative surface corresponding to the decorative image from the chip composition specification using a fabrication system.

### BRIEF DESCRIPTION OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic of a computer-based system implementing the present invention;

FIG. 2 is a screenshot of an input interface of the present invention;

FIG. 3 illustrates placement of chips on a canvas;

FIG. 4 is a screenshot of a user input interface of the present invention;

FIG. 5 is an example surface fabricated using the present invention;

FIGS. 6A-6B are flowcharts of operation of the present invention;

FIG. 7 is a flowchart of a fabrication operation of the present invention; and

FIG. 8 is a screenshot of an alternative embodiment of the user input interface of the present invention.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left may be used to describe the accompanying figures. The terminology includes the words above specifically mentioned, derivatives thereof, and words of similar import.

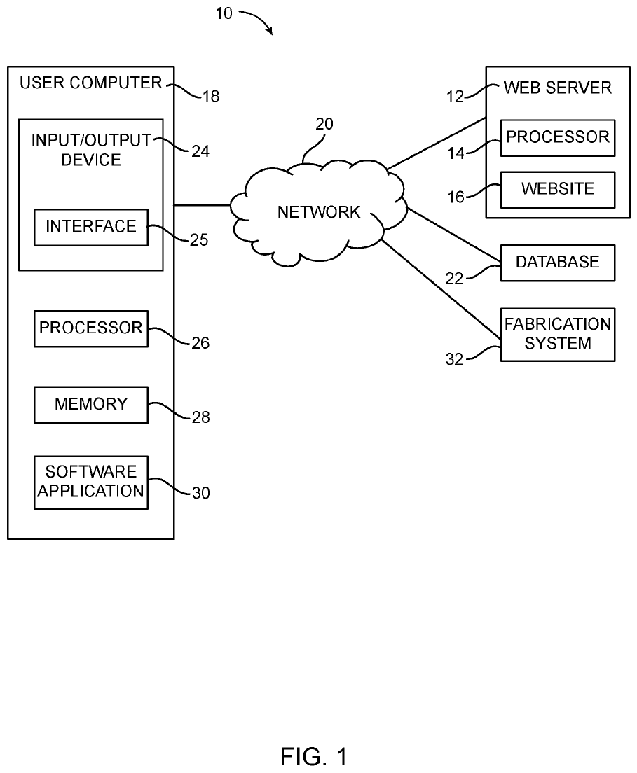

As shown in FIG. 1, the present invention is a system 10 and method for fabricating decorative surfaces. The system 10 includes a web server 12 having a processor 14 and a website 16 which a user computer 18 accesses through a network 20, which may include the Internet and/or other networks. The web server 12 and/or the user computer 18 access a database 22 through the network 20. The user computer 18 includes an input/output device 24, which may include a mouse, a keyboard, a touchscreen, and/or a display. The input/output device 24 includes an interface 25, such as a graphical user interface (GUI) and/or a web browser, for receiving user inputs and for displaying user-interactive screens. The user computer 18 also includes a processor 26, a memory 28, and a software application 30 which may be stored in the processor 26 and/or the memory 28, and which is executed by the processor 26. The system 10 also includes a fabrication system 32, accessed by the web server 12 and/or the user computer 18, for fabricating the decorative surfaces created by the user, as described below.

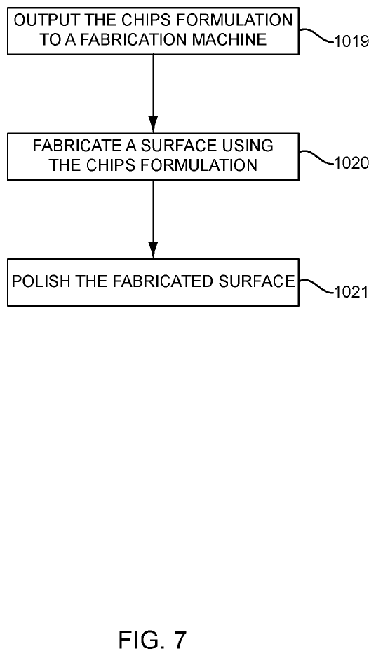

As described below, the system 10 uses the software application 30 which converts user inputs reflecting decorative choices to an image having such decorative choices, and then optionally implementing the output image and decorative choices to the fabrication system 32, which may be a fabrication machine, to manufacture the decorative surface, as shown in FIG. 7. The software application 30 may be installed on a hardware-based processor 26, such as a standalone personal computer (PC), or is installed as an app on a mobile phone or smart phone platform, or on a tablet. Other hardware for executing the software application 30 includes a mainframe computer, a server, a workstation, a laptop, and/or any known hardware. The processor 26 may include microprocessors such as VAX processors, Xeon, i7/i5/i3 series of INTEL processors, AMD processors, and/or any other known processors including graphic processing units (GPUs) and co-processors for increasing and/or improving execution speed and the handling of graphics.

The hardware also executes an operating system, such as Open VMS, OS/390, Unix, Linux, MAC OS, and WINDOWS, on compatible servers, personal computers, tablets, and other known computing devices, as well as mobile operating systems such as iOS and ANDROID, and/or any known operating system for executing and managing operations of the software application 30. Accordingly, the software application 30 may be platform independent. The software application 30 may be written in JAVA JDK, JAVA FX, and/or JRE, such as runtime deployment using the JRE 1.8 Update 171, as well as any known programming language such as JAVASCRIPT, C++, PYTHON, and C#. Examples of the source code of the software application 30, listed below, are written in JAVA. Accordingly, the software application 30 may be a browser-based application, app, or applet. The system 10, method, and software application 30 of the present invention may operate to be free to use, allowing users to generate and save decorative images without access to the image specifications or formulas specifying the decorative images. On the other hand, users with paid subscriptions may generate and save decorative images with the added ability to access image specifications or formulas specifying the decorative images. Other advantages of the system 10, method, and software application 30 of the present invention using a freemium business model may be provided to paying subscribers. For example, users with paid subscriptions may also have access to different color palettes, additional chip selections, and/or unlimited generation and saving of the number of created decorative images, which would not be available to non-paying free users.

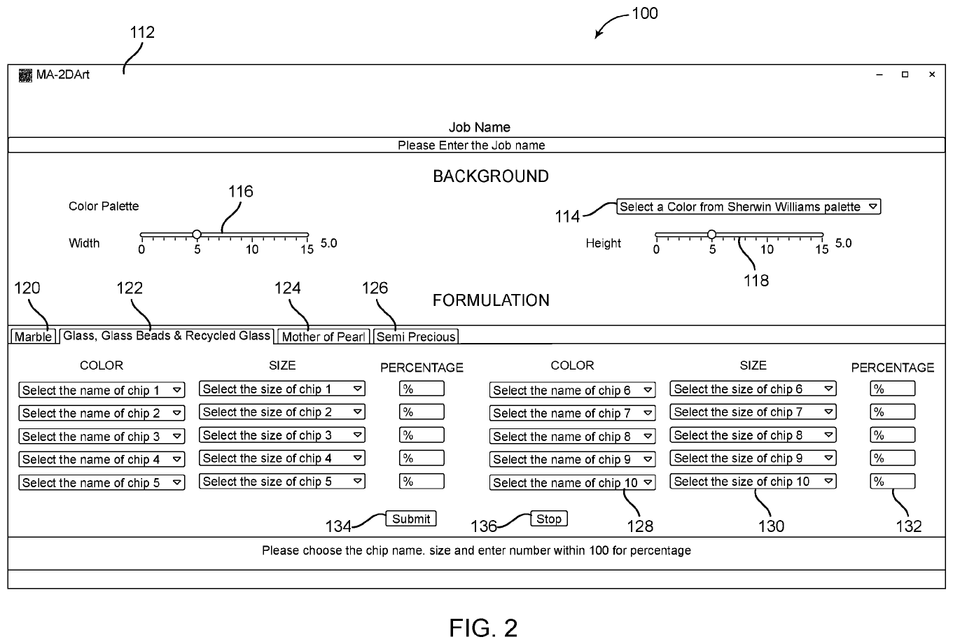

Referring again to FIG. 1, the system 10 has the user computer 18, which includes a memory 28, and the input/output device 24, such as a display, for displaying at least one interface 25 on a display screen. The interface 25 may be a graphic user interface (GUI) capable of accepting user inputs through a keyboard, mouse and/or touches and gestures on a touchscreen. By opening the software application 30 or clicking on an application icon on the interface 25 to execute the software application 30, a user input interface 100, as shown in FIG. 2, opens and is displayed on the display of the PC, smart phone, or tablet as the user input/output device 24. The user enters specified parameters and chooses from preloaded options using, for example, drop-down menus of lists of selectable options. As shown in FIG. 2, the user can enter a job name in input field 112 which will correspond to a name associated with the sample created from the formulation of chips selected by the user.

The user can also select a background color of the created sample from a drop-down menu 114 providing a list of names of colors in a predetermined palette, such as a palette of colors commercially available from SHERWIN-WILLIAMS. Other predetermined palettes include those commercially available from BENJAMIN MOORE and the INTERNATIONAL COLOR PALETTE. Alternatively, the user may also be able to select one palette from a plurality of palettes, such as the SHERWIN-WILLIAMS, BENJAMIN MOORE, and INTERNATIONAL COLOR PALETTE palettes using, for example, a drop-down menu of available palettes through the GUI.

The user can further select a size of the sample including a width and a height of the sample image on the screen using a width slider 116 and a height slider 118, respectively, with a range of 0 inches to 15 inches for each of the width and height. The user can also select a product category from each of tabs 120, 122, 124, 126; and can then select the respective colors, size and percentage of the chips for each selected product category to be included in the sample using the drop-down menus 128, 130 for the colors and sizes, respectively, and using the input text field 132 for the numerical percentages. Categories of the chips such as marble chips; glass, glass beads, and recycled glass; mother of pearl; and semi-precious stones are available on displayed tabs 120, 122, 124, 126, respectively, and user can choose a number of options, such as, for example, ten options, from each product category other than semi-precious stones, which has, for example, five options.

For a selected category, the options include the names of colors of the chips, such as Classic Marble, Boston Cream, New Pure White, Recycled Mirror, etc. The names of colors may also include color codes such as MP20, C33, W20, RC10, etc. The options also include sizes of the chips, with each size chosen from a different or the same category of chips which is separate in the software application. The sizes may have numerical values such as 0, 1, 2, 3, etc. indicating their relative sizes. For example, the sizes of the chips may be as shown in Table 1:

TABLE 1

| | DIMENSIONS |
|---|---|
| SIZE | RETAINED ON |
| NUMBER | THE SCREEN |
| 0 | 1/16 inch to 1/8 inch |
| 1 | 1/8 inch to 1/4/ inch |
| 2 | 1/4 inch to 3/8 inch |
| 3 | 3/8 inch to 1/2 inch |
| 4 | 1/2 inch to 5/8 inch |
| 5 | 5/8 inch to 3/4 inch |
| 6 | 3/4 inch to 7/8 inch |
| 7 | 7/8 inch to 1 inch |
| 8 | 1 inch to 9/8 inch |

Once the percentages for the chips, entered in the input text fields 132, add up to 100 percent, the Submit button 134 is clicked or otherwise actuated, causing the input interface 100 to take the specified user inputs, and feed the inputs into program variables for use during execution of the software application 30 to create the sample. If the user changes his/her mind regarding the selection of options while the software application 30 is executing, the user can actuate a Stop button 136 to stop the processing of the selected choices and inputs.

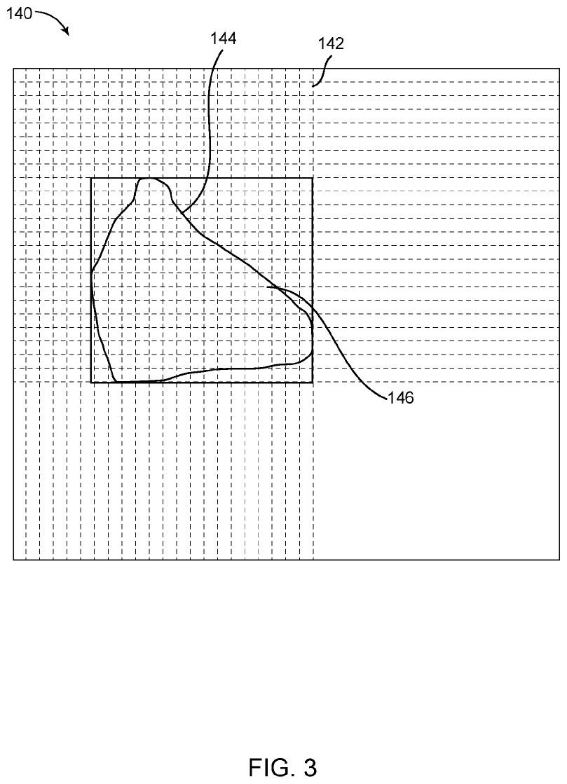

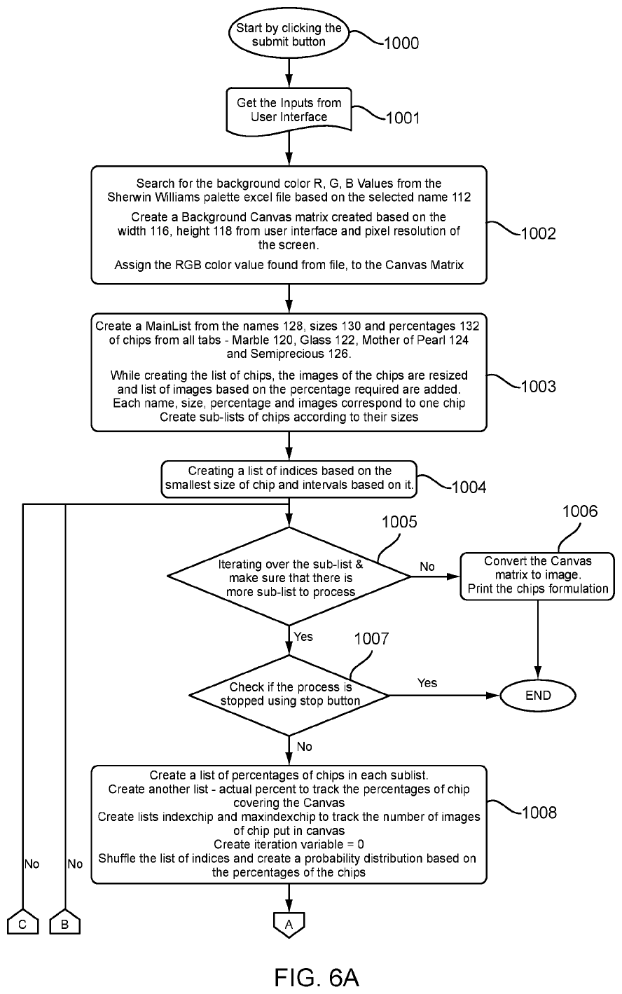

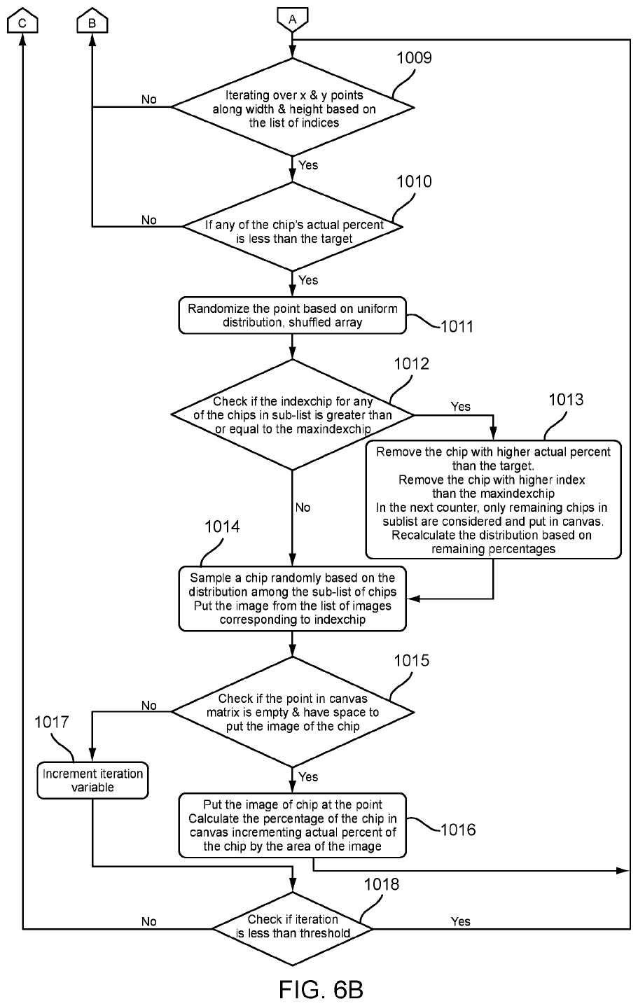

Referring to FIG. 3, the software application 30 runs according to the algorithm shown in FIGS. 6A-6B and 7 by sourcing the images of the chips and populating them over an input space as a canvas 140 with a matrix 142 of lines for placing the images 144 of the chips. The software application 30 checks if the RGB values of a portion 146 of the canvas is equal to the RGB values of the background color. For example, a portion 146 of the canvas may not yet be occupied by an image 144 of any chips, and so the software application 30 identifies areas where images 144 of chips may be placed. Each intersection in the image is considered as a point or pixel, and the image of the chip is also transformed to be positioned in the matrix 142. The relative point or pixel on the image of a chip is matched with an absolute point or pixel on the canvas, and once a match is detected, the color of the canvas at all points or pixels in the image is checked. If there is a match with a background color, then there is space for the image of the chip to be put into the input space 140 as a canvas for chips.

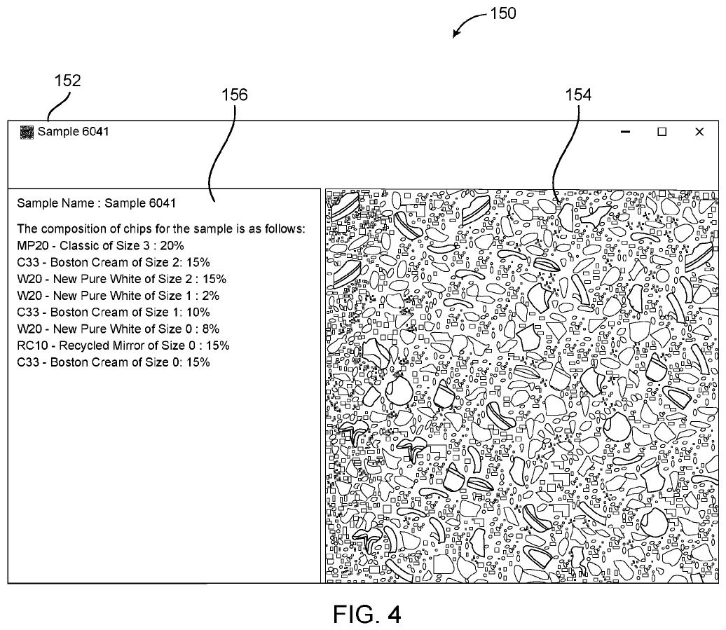

The software application 30 may take between about one minute and about ten minutes for the application to process the sample and generate an output, although runtime for the software application 30 may be approximately 90 seconds without losing quality of the output. Referring to FIG. 4, once the processing is completed by the software application 30, an output interface 150 is displayed, along with a report associated with a job name 152, obtained from the input field 112 in FIG. 2, and with the output interface 150 containing the image 154 with the corresponding formulation 156 of the chips chosen from the input interface 100 in FIG. 2. The sample image 154 and formulation 156 are saved in an output folder, associated with the job name 152, in the memory 28 in FIG. 1, or alternatively saved in the database 22 in FIG. 1.

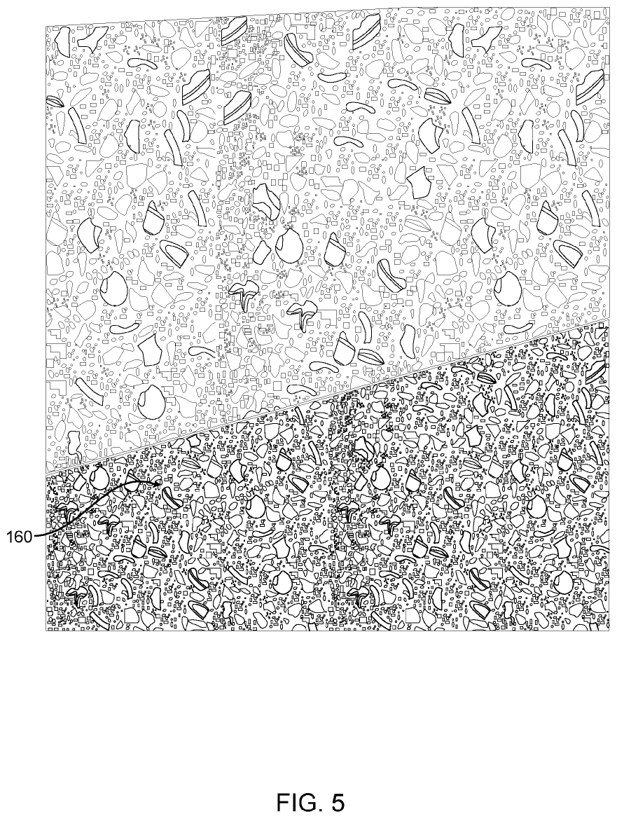

The user may be an architect, a designer, an architecture or sales representative, a professional sample maker, and/or a contractor. Once the user views the image 154 of the sample corresponding to the formulation or specification 156, the user may disapprove of the sample and its formulation 156, and so the percentages and sizes in the input interface 100 in FIG. 2 may be reset and the software application 30 can be used again by the user to reformulate a sample and its corresponding image 154 using a new formulation 156. However, once the user approves of the sample and its formulation 156 by viewing the image 154 corresponding to the formulation 156, the user may then apply the formulation 156 of the chips to generate an actual physical sample, by which the system 10 and method of the present invention fabricates an example surface 160, as shown in FIG. 5, using the method in FIG. 7, as described herein. The actual physical sample may be fabricated by manually mixing materials based on the formulation outputted and saved or via automated means based on the same.

Referring to FIGS. 6A-6B and 7 in greater detail, the software application 30 performs a method or algorithm starting in step 1000, in which the user enters the user inputs to the user interface 100 and clicks on the Submit button 134 to start processing the sample based on user specifications, including the user-set parameters in the input areas 112-132, such as the input fields, tabs, and drop-down menus of lists of selectable choices, as described herein.

In step 1001, once the Submit button 134 is clicked, the user inputs from the interface 100 are obtained which include a job/sample name 112, a background color name 114 from the SHERWIN-WILLIAMS palette, the selected width 116 and height 118 of the sample output, the names 128, sizes 130, and percentages 132 of the chips from marble, glass, mother-of-pearl, and semiprecious tabs 120-126, and the user inputs are assigned to application variables.

Then in step 1002, using the color name from fields 128, a search for the red, green, and blue (RGB) values of the color are determined from the SHERWIN-WILLIAMS palette color information EXCEL file, which stores an identification (ID), name, and RGB values separately. Once the RGB values of the color are obtained, a color matrix representing the canvas is created as in FIG. 3. The width and height of the matrix is dependent on the width and height of the sample specified by the user, as well as the pixel resolution of the screen upon which the input interface 100 is displayed. The width of the matrix is the input width from the user multiplied by the screen resolution to display the right size. Similarly, the height of the matrix is the input height from the user multiplied by the screen resolution to display the right size. The values of the canvas matrix are assigned the RGB values from the palette 114.

In step 1003, the software application 30 obtains the names, sizes and percentages of the chips from the user interface 100, and a single chip is identified by its size, name and percentage, hence the information of the single chip is tied together which is convenient later to access each chip. In this manner, multiple chips are combined to form a main list containing the names, sizes and percentages of chips from all of the tabs 120-126, specifying marble, glass, mother-of-pearl, and semiprecious. While creating the main list of chips, the images of the chips are resized, and a list of images based on the specified and required percentage are added. Each name, size, percentage, and image correspond to one chip. The main list of chips is later subdivided into sub-lists based on their sizes. Each sub-list corresponds to a list of chips of a respective size. In addition, the background color is initialized based on the color selection. Step 1003 may be implemented as follows:

```
//Initializing the screen and background
screenpix=new double[wd*pix][ht*pix];
screenval=new Color[wd*pix][ht*pix];
for(int i=0;i<wd*pix;i++) {
  for(int j=0;j<ht*pix;j++) {
    screenpix[i][j]=100;
    }
  }
  for(int i=0;i<wd*pix;i++) {
    for(int j=0;j<ht*pix;j++) {
      screenval[i][j]=new Color(R,G,B); //Initialize Color Value Matrix
      }
    }
```

In step 1004, a list of indices with jumps, based on the smallest size of the chip, is created for x axis and y axis traversal. These indices are the indices where the images of the chips will be placed on the screen, such as shown in FIG. 3. Step 1004 may be implemented as follows:

```
double pixelsizechip= (getimsizeint(−2));
Double[ ] xaxisval = new Double[(int) (wd/pixelsizechip)];
xaxisval[0]=(double) 0;
for(int i=1;i<xaxisval.length;i++) {
  xaxisval[i]=(double) Math.min(xaxisval[i−1]+pixelsizechip*pix, wd*pix);
}
double[ ] xaxisval1 =ArrayUtils.toPrimitive(xaxisval);
Double[ ] yaxisval = new Double[(int) (ht/pixelsizechip)];
yaxisval[0]=(double) 0;
for(int i=1;i<yaxisval.length;i++) {
    yaxisval[i]=(double) Math.min(yaxisval[i−1]+pixelsizechip*pix, ht*pix);
}
double[ ] yaxisval1 = ArrayUtils.toPrimitive(yaxisval);
```

In step 1005, each sub-list is chosen and iterated over in a descending manner. The sub-list with the biggest size is chosen first and then followed by sub-lists having smaller sizes. At each iteration, the software application 30 checks if there are more sub lists. Step 1005 may be implemented as follows:
for(int q=1;q<S1.size( );q++)

In step 1006, once all sub-lists are processed, that is, there are no more sub-lists to process, the output image 154 is created from the canvas matrix 142, and the formulation of the chips is printed or otherwise output to the user. The output window 150 displays the image 154 and its associated formulation 156. The method may then end and optionally a new sample may be created. Alternatively, the method proceeds to perform steps 1019-1021 in FIG. 7, as described herein, to fabricate a physical sample corresponding to the image 154 and its associated formulation 156.

However, if in step 1005, there are more sub-lists to process, the method proceeds to step 1007, such that every time a sub-list is processed, the method checks if the Stop button 136 is pressed or not. If the Stop button 136 is pressed, then the method is terminated and a new sample can be created.

However, if the Stop button 136 is not pressed in step 1007, then the method proceeds to step 1008, in which a list of percentages of the chips in a sub-list is created. Another list corresponding to the actual percentages list is created to track the chips covering the canvas area 140, shown in FIG. 3. Another set of lists using indices indexchip and maxindexchip are created. Indexchip is used to traverse through the list of images corresponding to a chip of one size. Maxindexchip is the maximum index value which indexchip can reach since Maxindexchip corresponds to the total number of images of the chip. Indexchip is iterated every time an image of a chip is put on the screen; that is, the canvas 140, so that the next image of a chip is different one. An iteration variable is also created and initially set to zero, with the iteration variable used to terminate the processing of a sub-list if the processing is running for a long time. In an example embodiment, a multiplier is used since the chips need to cover, for example, only 70% of the surface of the canvas 140. The list of indices is then shuffled, and a probability distribution is created based on the percentages of the chips. Step 1008 may be implemented as follows:

```
int[ ] indexchip=new int[s1.length];
int[ ] maxindexchip=new int[s1.length];
for(int i=0;i<s1.length;i++) {
  maxindexchip[i]=s1[i].maxindex;
}
Arrays.fill(indexchip,0);
double[ ] targetp=new double[s1.length];
double[ ] actualp=new double[s1.length];
int[ ] actuals=new int[s1.length];
Arrays.fill(actualp, 0);
Arrays.fill(actuals, 0);
for(int i=0;i<targetp.length;i++) {
  if(s1[i].size<2) {
    multiplier=0.90;
    targetp[i]=0.90*s1[i].percent;
  }else{
    multiplier=0.75;
    targetp[i]=0.75*s1[i].percent;
  }
}
```

Then in step 1009, the method traverses over the canvas matrix 142 in the x and y directions, and the x and y points are iterated over based on the list of indices until the width and height of the canvas matrix is reached. If the width or height are not reached, then the method returns to step 1005, but if the width and height are reached, then the method proceeds to step 1010. Step 1009 may be implemented as follows:

for(int u=0;u<xaxisval1.length;u++) {
for(int v=0;v<yaxisval1.length;v++) {

In step 1010, at each point of iteration of the sub-list, the actual percentages list is checked to see if any of the chips exceeds the required percentage of the specific chips in the canvas 140. If not, the method returns to step 1005; otherwise, the method proceeds to step 1011. Step 1010 may be implemented as follows:
if(Percentlessthan(actualp,targetp) && (actualp.length!=0 && targetp.length!=0))

In step 1011, the point where the image of a chip is to be placed on the canvas 140 is randomized. Based on the number of sizes in the formulation and the size of chips, the placement of a chip is either based on a uniform distribution of the index of the list or it is based on shuffled list of indices. Step 1011 may be implemented as follows:

xaxis=(int) xaxisv[new DiscreteUniformGenerator(0,xaxisv.length−1,twist1).nextValue( )];
yaxis=(int) yaxisv[new DiscreteUniformGenerator(0,yaxisv.length−1,twist1).nextValue( )];
or
xaxis=(int) xaxisv[u];
yaxis=(int) yaxisv[v];

In step 1012, at each point of the iteration of a sub-list, the actual percentages list is checked to see if any of the chips exceeds the required percentage of the specific chip in the canvas 140, by checking if there is a chip where the indexchip of the chip is greater than or equal to the maxindexchip. If so, the method proceeds to step 1013; otherwise, the method proceeds to step 1014. Step 1012 may be implemented as follows:

int indexgtr=whichindexgreatereqlto(indexchip,maxindexchip);
if(indexgtr!=100)

In step 1013, if there is a chip where the actual percentage of the specific chip in the canvas 140 is greater than the required percentage in the canvas 140, the specific chip is removed from the sub-list and everything related to the specific chip is removed from the required and actual percentages list, the indexchip list, and the maxindexchip list. The distribution based on the remaining chips is recalculated, and the method proceeds to step 1014. Step 1013 may be implemented as follows:

```
tempar=removeElementpair(tempar,indexgtr);
targetp=removeElementdouble(targetp,indexgtr);
actualp=removeElementdouble(actualp,indexgtr);
actuals=removeElementint(actuals,indexgtr);
indexchip=removeElementint(indexchip,indexgtr);
maxindexchip=removeElementint(maxindexchip,indexgtr);
discreteProbabilities=removeElementdouble(discreteProbabilities,indexgtr);
numsToGenerate=removeElementint(numsToGenerate,indexgtr);
double percentafterremoval=0;
for(int i=0; i<tempar.length;i++) {
  percentafterremoval=percentafterremoval+ tempar[i].percent;
  }
if(tempar.length==1) {
  percentafterremoval=100;
  }
for(int i=0; i<tempar.length;i++) {
  discreteProbabilities[i]=(double) (tempar[i].percent)/percentafterremoval;
  numsToGenerate[i]= i;
  }
distribution= new EnumeratedIntegerDistribution(numsToGenerate, discreteProbabilities);
```

In step 1014, a chip is randomly chosen from the sub-list based on a probability distribution, based on the target percentages of the chips of one size, and the image of the chip is found from the list of images corresponding the name and size of the chip and corresponding to indexchip. Step 1014 may be implemented as follows:

chip=distribution.sample( );
ImgPt in=new ImgPt(new Point(xaxis,yaxis),tempar[chip].arryimgs[indexchip[chip]]);

In step 1015, before putting the image in the canvas, the canvas is checked to determine if there is space in the canvas corresponding to the point in the matrix selected from a counter, and if such space can fit the image of the chip. If so, the method proceeds to step 1016; otherwise, the method proceeds to step 1017. Step 1015 may be implemented as follows:
boolean b=isempty(in,chip);

In step 1016, if there is space available, the image of the chip is put on the canvas 140. The actual percentage corresponding the chip, whose image was inserted in the canvas 140, is incremented by the area of the image of the chip put in the canvas and the total area of the canvas 140. Indexchip is also incremented to get the next image from the list of images. The method then returns to step 1009. Step 1016 may be implemented as follows:

actuals[chip]=actuals[chip]+tempar[chip].areaofchips[indexchip[chip]];
indexchip[chip]=indexchip[chip]+1;
double pr=(double) actuals[chip]*100.0/(wd*pix*ht*pix);
actualp[chip]=pr;

In step 1017, if there is no space for the image of the chip on the canvas 140, the iteration variable is incremented, and the method proceeds to step 1018. Step 1017 may be implemented as follows:
iter=iter+1;

In step 1018, if the iteration variable exceeds a threshold then processing of the sub-list is ended, and a next sub-list is chosen to be processed. This is done to prevent the counter from going on for a long time, as a safety measure. Placing of the chips is dependent of the position and area of the chips. If the chips are not placed, the iteration variable increments with upper limit threshold, as a safety measure, and is set to the product of the index arrays for x and y. The method then checks if the iteration is less than the threshold. If so, the method returns to step 1009; otherwise, the method returns to step 1005. Step 1018 may be implemented as follows:
Iter>=xaxisval1.length*yaxisval1.length(Threshold)

Referring back to step 1006, instead of terminating after outputting the image of the sample, the method may proceed to fabricate the sample in steps 1019-1021 in FIG. 7. FIG. 7 is a flowchart of a fabrication operation of the present invention, in which the method outputs the chips formulation 156 in FIG. 4 to the fabrication system 32, such as a fabrication machine known in the art, in step 1019. For example, the fabrication system 32 or machine may take the specifications of the chips formulation 156 and randomly mix the selected amounts and sizes of chips to create a composition of chips matching the formulation 156.

The method then fabricates a decorative surface, such as the surface 160 in FIG. 5, in step 1020 using the fabrication system 32 or machine. For example, the fabrication system 32 or machine may pour or otherwise place the composition of chips in a frame or other structure with, for example, epoxy or other adhering substances known in the art, where the composition will harden to form the decorative surface having the formulation 156. The method then polishes the fabricated surface in step 1021 using a polishing machine known in the art, to generate the final version of the decorative surface as in FIG. 5, and corresponding to the chips formulation 156 and the image 154 in FIG. 4.

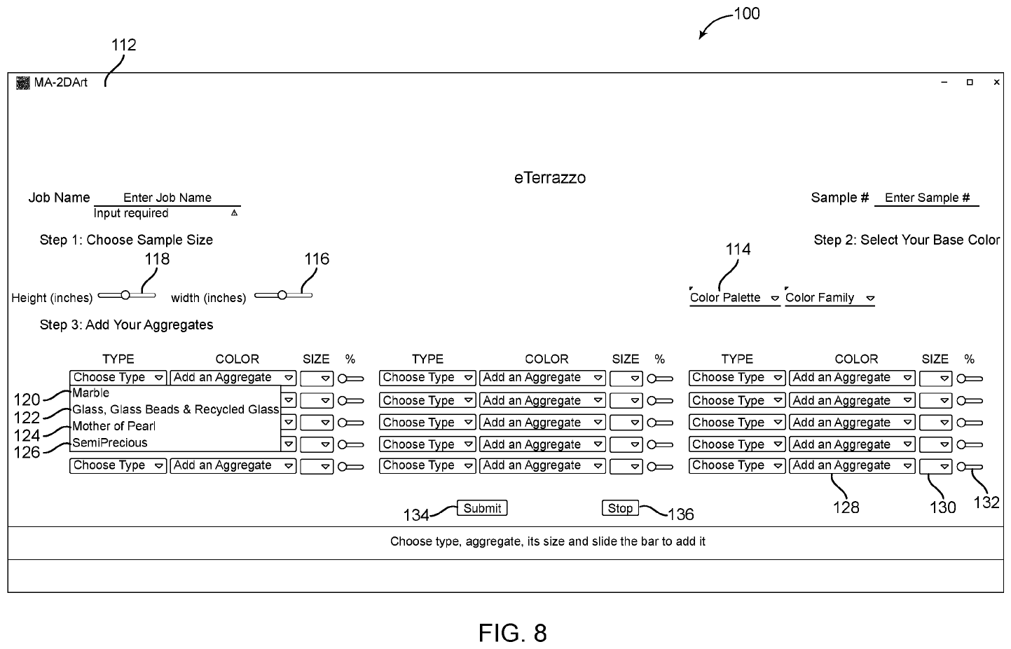

FIG. 8 is a screenshot of an alternative embodiment of the user input interface 100 of the present invention. The user input interface 100 in FIG. 8 is similar to the user input interface 100 in FIG. 2, but having different user controls. For example, in FIG. 8, the user input interface 100 has an input field for a sample number, allowing the user to identify a sample from among a number of samples stored in the same job name. In addition, the drop-down menu 114 providing a list of names of colors in a predetermined palette has an additional adjacent drop-down menu for specifying a color family within the selected color palette, such as a brown color family providing a set of brown hues for the chips, while a silver color family provides a set of silver hues for the chips.

As shown in FIG. 8, a drop-down menu allows the user to select one category of chip from among the categories 120-126 of chips, such as marble 120; glass, glass beads, and recycled glass 122; mother-of-pearl 124; and semi-precious stones 126. Also shown in FIG. 8, a percentage selector 132 may be in the form of a slider instead of an input field for inputting a percentage.

The present invention may be embodied in other specific forms without departing from its spirit or essential characteristics. The described embodiments are to be considered in all respects only as illustrative and not restrictive. The scope of the invention, therefore, will be indicated by claims rather than by the foregoing description. All changes, which come within the meaning and range of equivalency of the claims, are to be embraced within their scope.

What is claimed is:

1. A system comprising:
an input device for receiving user inputs from a user;
a processor, executing a predetermined software application, for processing the user inputs to create a decorative image, wherein the decorative image represents a plurality of physical chips constituting a physical decorative surface; and
a fabrication system for fabricating the decorative surface corresponding to the decorative image.

2. The system of claim 1, further comprising:
a display; and
a web server for generating a website on the display;
wherein the display displays a browser, and displays the decorative image through the browser; and
wherein the user enters the user inputs to the website through the browser.

3. The system of claim 1, wherein the processor generates a chip composition specification of the decorative image from the user inputs.

4. The system of claim 3, wherein the fabrication system fabricates the decorative surface corresponding to the decorative image from the chip composition specification.

5. The system of claim 1, wherein the user inputs are selected from the group of chip type, chip color, chip size, and chip percentage in the decorative image.

6. The system of claim 5, wherein the user inputs indicate a first color palette selected from a plurality of predetermined color palettes, wherein the chip color is determined by the first color palette.

7. A system comprising:
an input device for receiving user inputs from a user;
a processor, executing a predetermined software application, for processing the user inputs to create a decorative image; and
a display for displaying the decorative image.

8. The system of claim 7, further comprising:
a fabrication system for fabricating a physical decorative surface corresponding to the decorative image.

9. The system of claim 7, further comprising:
a web server for displaying a website on the display;
wherein the display displays a browser, and displays the decorative image through the browser; and
wherein the user enters the user inputs to the website through the browser.

10. The system of claim 7, wherein the decorative image represents a plurality of physical chips constituting a physical decorative surface.

11. The system of claim 10, wherein the processor generates a chip composition specification of the decorative image from the user inputs.

12. The system of claim 11, further comprising:
a fabrication system for fabricating the physical decorative surface corresponding to the decorative image from the chip composition specification.

13. The system of claim 10, wherein the user inputs are selected from the group of chip type, chip color, chip size, and chip percentage in the decorative image.

14. The system of claim 13, wherein the user inputs indicate a first color palette selected from a plurality of predetermined color palettes, wherein the chip color is determined by the first color palette.

15. A method comprising:
receiving user inputs from a user using an input device;
executing a predetermined software application using a processor for processing the user inputs, thereby creating a decorative image; and
displaying the decorative image on a display.

16. The method of claim 15, further comprising:
fabricating a physical decorative surface corresponding to the decorative image using a fabrication system.

17. The method of claim 15, further comprising:
displaying a website on the display using a web server;
displaying a browser on the display;
displaying the decorative image through the browser; and
entering, by the user, the user inputs to the website through the browser.

18. The method of claim 15, wherein the user inputs are selected from the group of chip type, chip color, chip size, and chip percentage in the decorative image.

19. The method of claim 15, wherein the decorative image represents a plurality of physical chips constituting a physical decorative surface.

20. The method of claim 19, further comprising:
generating a chip composition specification of the decorative image from the user inputs; and
fabricating the physical decorative surface corresponding to the decorative image from the chip composition specification using a fabrication system.
